(19) United States
(12) Patent Application Publication
(10) Pub. No.: US 2003/0076759 A1
(43) Pub. Date: Apr. 24, 2003

(54) Writing failure preventing method and device for CD-Writers

(76) Inventor: Vincent Yu, Taipei (TW)

Correspondence Address: RABIN & BERDO, P.C., Suite 500, 1101 14th Street, N.W., Washington, DC, 20005, US

(21) Appl. No.: 10/271,781

(22) Filed: Oct. 17, 2002

(30) Foreign Application Priority Data
Oct. 18, 2001 (TW) 90125846

(51) Int. Cl. G11B 20/00

(52) U.S. Cl. 369/53.1

(57) ABSTRACT

A method and device that prevents CD-Writers from writing-failure through a real-time monitor of CD-Writer temperature is provided. The writing-failure preventing device for CD-Writers comprises: a thermo-sensor, a thermo-fetching unit and a writing-setting module. The thermo-sensor installed inside the CD-Writer is used to measure its temperature, whereas the thermo-fetching unit fetches the temperature and has it displayed on a user interface. The writing-setting module has a number of adjustable writing-settings. The user can promptly adjust writing-settings according to the CD-Writer's temperatures to reduce writing speed or correct output Laser amplitude via the user interface. The CD-Writer will perform CD writing within an appropriate range of temperature according to the adjusted settings of writing.

This application incorporates by reference Taiwan application Serial No. 090125846, Filed Oct. 18, 2001.

### BACKGROUND OF THE INVENTION

1. Field of the Invention

The invention relates in general to a writing failure preventing method and device, and more particularly to a writing failure preventing method and device using a real-time monitor.

2. Description of the Related Art

As the demand for high capacity storage memory media getting stronger and stronger, the role that compact disks (CD) play has become more and more important. The writing of a CD relies on the chemical changes produced when the R/W head inside the CD-Writer focuses Laser rays onto the dye layer, resulting in a high temperature and a lower rate of reflection for those points hit by Laser rays. Points on the dye layer are called ‘pits’ or ‘lands’ depending on whether they have been hit by Laser rays or not. Lands have a higher rate of reflection than pits have. Pits together with lands form (0 and 1) signals representing digital information.

The thermal source of Laser rays must hit the CD precisely within a correct area with an appropriate density. However, due to the poor quality of the CD being used, the thermal-interference effect which is caused by high temperature of Laser rays occur resulting in an unequal length of pits in the same unit. This will lead to bias of Laser ray wavelength and errors in the fetching of data. What is more, the ventilation environment greatly influences the life-expectancy of a R/W head. Since a certain amount of heat will be generated when Laser rays are emitted from the R/W head, a poor ventilation environment will worsen the aging of the R/W head, resulting in bias and a poor output amplitude of Laser emitting or a failed access to the CD.

An overheated CD-Writer and poor ventilation due to overdue writing time or the use of a poor quality CD always end up with writing instability. Therefore the thermal control for a R/W head directly influences the quality of CD writing. Nevertheless, none of current writing softwares provides a real-time function to monitor the t temperature of a CD-Writer. Since the user is unable to gain a sound knowledge of the temperature of a CD-Writer, a high probability of writing failure is expected.

### SUMMARY OF THE INVENTION

It is therefore an object of the invention to provide a method and device preventing the writing failure of a CD-Writer by means of a real-time temperature monitor to adjust the internal temperature of a CD-Writer and avoid the writing failure due to an overheated CD-Writer.

According to the object of the invention, a method preventing the writing failure of a CD-Writer is provided. The temperature of the CD-Writer is measured, fetched and displayed on a user interface by which the settings of CD writing are reset and adjusted. By reducing writing speed and by correcting Laser output amplitude, the temperature of a CD-Writer is adjusted.

According to the object of the invention, a device including a thermo-sensor, a thermo-fetching unit and a writing-setting module that prevents writing failure of a CD-Writer is provided. The thermo-sensor used to measure the temperature of a CD-Writer is installed inside the CD-Writer. The thermo-fetching unit and writing-setting module are integrated in an application program, wherein the thermo-fetching unit fetches the CD-Writer temperature and has it displayed on the user interface while the writing-setting module comprises a number of adjustable modules. The application program drives the CD-Writer to perform the writing of a CD according to these settings.

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1 shows a block diagram of a writing-failure preventing device for CD-Writers according to a preferred embodiment of the invention; and

FIG. 2. shows a flowchart of a writing-failure preventing method for CD-Writers according to a preferred embodiment of the invention.

### DESCRIPTION OF THE PREFERRED EMBODIMENT

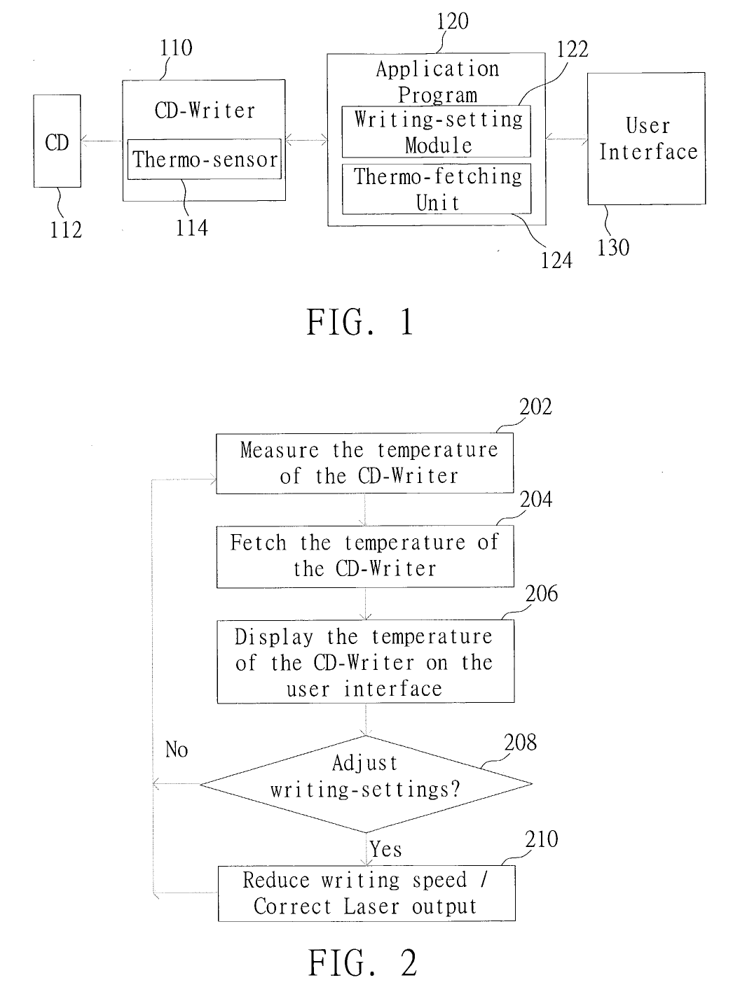

Please refer to FIG. 1, a block diagram of a writing-failure preventing device for CD-Writers according to a preferred embodiment of the invention. The CD-Writer temperature monitoring device comprises: the thermo-sensor 114 and the application program 120, wherein the application program 120 further comprises the writing-setting module 122 and the thermo-fetching unit 124. During the writing of a CD, the CD-Writer temperature monitoring device according to the invention adjusts the internal temperature of the CD-Writer 110 in a real-time manner avoiding an overheated CD-Writer 110 due to an overdue writing time or a poor quality CD 112 being used.

As shown in FIG. 1, the thermo-sensor 114 is installed inside the CD-Writer 110 (near the R/W head for instance) and is used to measure the internal temperature of the CD-Writer 110; the thermo-fetching unit 124 fetches the temperature taken by the thermo-sensor 114 and has the reading displayed on the user interface 130; the writing-setting module 122 comprises a number of adjustable settings of writing, such as writing speed and Laser output amplitude, while the application program 120 drives the CD-Writer 110 to perform the writing of CD 112 according to these settings.

Please refer to FIG. 1 and FIG. 2, a flowchart of a writing-failure preventing method for CD-Writers according to a preferred embodiment of the invention. The writing-failure preventing method according to the invention comprises the following steps:

Step 202: the thermo-sensor 114 measures the temperature in the neighbourhood of the R/W head.

Step 204: the thermo-fetching unit 124 fetches the temperature of the CD-Writer and transmits it to the user interface 130 using parameters for instance.

Step 206: the reading of the CD-Writer temperature is displayed on the user interface 130 such that the internal temperature of the CD-Writer is known.

Step 208: Decide whether to adjust the settings of CD writing or not. If the temperature for the CD-Writer is too high then go to step 210. If the temperature falls within a normal range, return to step 202.

Step 210: Adjust the internal temperature of the CD-Writer to be within a normal range by reducing the writing speed of the CD 112 or by correcting the Laser output amplitude to change the wavelengths of the Laser rays. Return to step 202, and once again measure the CD-Writer temperature, fetch it and change the temperature displayed accordingly. Then continually monitor the CD-Writer temperature.

Before or during the writing process, the user can adjust the temperature by changing the settings of writing via the writing-setting module 122 or by using an air-conditioner to change the temperature in the environment according to the temperature that the application program 120 displays.

A device and method that prevents the writing-failure of a CD-Writer disclosed in the abovementioned embodiment according to the invention provides a real-time function that monitors the temperature of a CD-Writer. By means of the temperature information of a CD-Writer that the application program provides, the user can directly fetch the information regarding the current temperature of the CD-Writer from the user interface so as to promptly adjust the settings of CD writing. The CD-Writer will then perform CD writing within an appropriate range of temperature according to the adjusted writing-settings, avoiding writing instability, reducing failure rate of CD writing and improving writing quality.

While the invention has been described by way of example and in terms of the preferred embodiment, it is to be understood that the invention is not limited to the disclosed embodiment. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method that prevents CD-Writers from writing-failure, comprising the following steps:
(A) measuring the temperature of the CD-Writer;
(B) fetching the temperature of the CD-Writer;
(C) displaying the temperature of the CD-Writer on a user interface; and
(D) adjusting at least one of the writing-settings in response to said temperature.

2. A method according to claim 1, wherein step (A) is repeated to once again measure the CD-Writer temperature, fetch it and change the temperature displayed in the wake of step (D).

3. A method according to claim 1, wherein the adjustment of writing-settings in step (D) comprises reducing writing speed.

4. A method according to claim 1, wherein the adjustment of writing-settings in step (D) comprises correcting Laser output amplitude.

5. A method according to claim 1, wherein the temperature of the CD-Writer is measured via a thermo-sensor.

6. A method according to claim 1, wherein the temperature of the CD-Writer is fetched via a thermo-fetching unit.

7. A method according to claim 6, wherein the thermo-fetching unit transmits the CD-Writer temperature to a user interface using parameters and has temperature information displayed on the user interface.

8. A method according to claim 1, wherein the CD-Writer is driven by an application program which has a writing-setting module with a number of adjustable writing-settings.

9. A method according to claim 1, wherein the CD-Writer performs CD writing according to these writing-settings.

10. A device that prevents CD-Writers from writing-failure, comprising:
a sensor used to measure the temperature of the CD-Writer; and
an application program comprising:
a thermo-fetching unit used to fetch the CD-Writer temperature and have it displayed on a user interface; and
a writing-setting module with a number of adjustable writing-settings in response to said temperature, wherein the application program drives the CD-Writer to perform CD writing according to these settings.

11. A device according to claim 10, wherein the thermo-fetching unit transmits the temperature of the CD-Writer to the user interface using parameters.

12. A device according to claim 10, wherein the writing-settings comprises writing speed.

13. A device according to claim 10, wherein the writing-settings comprises Laser output amplitude.
